(19) United States
(12) Patent Application Publication
(10) Pub. No.: US 2017/0265233 A1
(43) Pub. Date: Sep. 14, 2017

(54) APPARATUS AND METHOD OF CONNECTING A MOBILE DEVICE TO A FIELD DEVICE

(71) Applicant: SICK AG, Waldkirch (DE)

(72) Inventor: Martin BEHA, Waldkirch (DE)

(21) Appl. No.: 15/451,622

(22) Filed: Mar. 7, 2017

(30) Foreign Application Priority Data
Mar. 8, 2016 (DE) 102016104141.6

(51) Int. Cl. H04W 76/02; H04W 12/04; H04W 4/14

(52) U.S. Cl. CPC H04W 76/021; H04W 4/14; H04W 12/04; H04W 84/12

(57) ABSTRACT

An apparatus and method for connecting a mobile device having a field device via a wireless LAN access point includes a server having a web service. The field device has a first module for generating a wireless LAN key and the server has a web service having a second module for generating a wireless LAN key. The first module and the second module respectively generate identical wireless LAN keys. The field device is identified by the mobile device by means of at least one piece of identification information. The mobile device transmits the identification information of the field device to the server having the web service. The server transmits the wireless LAN keys associated with the identification information to the mobile device. The mobile device is wirelessly connected via the wireless LAN access point to the field device by means of a wireless LAN name and the wireless LAN key.

The present invention relates to a method of connecting a mobile device to a field device via a wireless LAN access point, wherein a server having a web service provided, and to an apparatus for connecting a mobile device to a field device via a wireless LAN access point, wherein a server having a web service is provided.

The establishment of a connection to a field device for the purpose of taking into operation, the parametrization and the operation should be possible via a wireless interface in accordance with the state of the art. Preferably wireless LAN and Blue-tooth are used in this respect. These two technologies enable the operation of the field device via a mobile device e.g. a smartphone, a tablet computer and a note-book, etc.

In the following specifically the establishment of a connection per wireless LAN will be considered. So that a user having a mobile device can connect to a field device, the field device has to have a wireless LAN access point. In order to register at the wireless LAN access point a wireless LAN name (WLAN-SSID) and a wireless LAN key are additionally required.

With the aid of this wireless LAN key the communication between client, namely the mobile device and the wireless LAN access point are coded. Any one that knows the wireless LAN key and is present within the range of the wireless LAN network can connect to the device or listen to the communication.

Such a non-controlled access must however be prevented.

Field devices can be connected to a so-called RADIUS server by means of a network connection. Behind the scenes, the RADIUS server requires a corresponding infrastructure that has to be administrated and looked after. Additionally the field device must necessarily be connected with the RADIUS server.

Also the installation of a specific APP in connection with a near field communication unit can ensure a secure authentication. The installation of a specific APP is however not always possible for reasons of security and moreover requires an additional demand in effort and cost. Also the presence of a near field communication unit requires additional hardware components.

Also a manual administration of a wireless LAN key and a targeted forwarding are possible.

An object of the invention consists therein of making available a secure connection between a mobile device and a field device without the field device having an internet connection.

The object is satisfied in accordance with claim 1 by means of a method of connecting a mobile device to a field device via a wireless LAN access point, wherein a server having a web service is provided, wherein the field device has a first module for generating a wireless LAN key, the server having the web service having a second module for generating a wireless LAN key, wherein the first module and the second module respectively generate identical wireless LAN keys, wherein the field device is identified via at least one piece of identification information by the mobile device, wherein the mobile device transmits the identification information of the field device to the server having the web service, wherein the server having web service transmits the wireless LAN key associated with the identification information to the mobile device, wherein the mobile device is wirelessly connected to the field device via the wireless LAN access point by means of a wireless LAN name and the wireless LAN key.

The object is further satisfied by an apparatus for connecting a mobile device to a field device via a wireless LAN access point, wherein a server having a web service is provided, the field device has a first module for generating a wireless LAN key, the server having the web service having a second module for generating a wireless LAN key, wherein the first module and the second module are configured to respectively generate identical wireless LAN keys, wherein the field device can be identified by the mobile device via an identification information, wherein the mobile device is configured to transmit the identification information of the field device to the server having the web service, wherein the server having the web service is configured to transmit the wireless LAN key associated with the identification information to the mobile device, wherein the mobile device is wirelessly connected to the field device via the wireless LAN access point by means of the wireless LAN name and the wireless LAN key.

In particular the invention relates to field devices of process automation, this thus means for example transmitters, in particular O₂ transmitters, field devices for smoke gas investigation, such as e.g. particle measurement devices, laser scanners and the like.

A wireless LAN (Local Area Network) access point or wireless access point, in particular also referred to as a wireless point of access or also as a base station, is an electronic device that functions as an interface for wireless communication devices. End devices, namely field devices establish a wireless connection to the wireless access point by means of wireless adapters, with the wireless access point being connected to a fixedly installed communication network, for example by way of a cable. Commonly wireless LAN access points connect notebooks and other mobile end devices using installed wireless adapters via a Wireless Local Area Network (wireless LAN, radio network, or wifi network), to a Local Area Network (LAN) or to a different cable bound data network (e.g. a telephone network).

The wireless LAN name is also referred to as SSID, with SSID standing for Service Set Identifier. In accordance with the norm 802.11 of the Institute of Electrical and Electronics Engineers, service set refers to all devices in a wireless LAN. A Service Set Identifier (SSID) is a freely selectable name of a service set by way of which it can be addressed.

A wireless LAN access point can bear a plurality of wireless LAN names at the same point in time which led to a greater importance with the introduction of authentication for wireless LANs. Such multiple wireless LAN names enable a wireless LAN access point of making available a plurality of Virtual Local Area Networks.

A wireless LAN name can be up to 32 bytes long and correspondingly comprise up to 32 ASCII characters. If a device transmits a data frame with an empty wireless LAN name, the wireless LAN access point then transmits each wireless LAN name that is supported by the wireless LAN access point as a response. From this response the device can generate a list that enables the user a selection of a wireless LAN name.

The wireless LAN key is a secure key. For example Wi-Fi Protected Access 2 (WPA2) is the implementation of a security key respectively of a security standard for radio networks in accordance with the wireless LAN standards IEEE 802.11a, b, g, n and ac and is based on the Advanced Encryption Standard (AES).

A resource identifier (Uniform Resource Locator, abbreviation URL) identifies and localizes a resource, such as e.g. a website via which the access method to be used, e.g. the network protocol used, such as HTTP or FTP and the position of the resource in the computer network. The current effective is published as RFC 1738. The pertinent RFC specifications are industrial standards of the Internet Engineering Task Force (IETF).

Resource identifiers are a sub-class of the general identification indicators using Uniform Resource Identifiers (URIs). As URLs are the first and most frequently used kind of URIs the terms are frequently used as synonyms. In the general use of the language resource identifiers are also referred to as internet or web addresses, with in this way the resource identifiers of websites being specifically meant in the same way as the internet and the World Wide Web are frequently equated in a colloquial manner.

In accordance with the invention no additional software and/or application/APP has to be installed. The operation of an additional server infrastructure can likewise be omitted. Also the assembly of an access infrastructure by means of a customer in the field is not required.

By way of the authentication at the web service only the authorized users/persons obtain an access to the wireless LAN access point of the field device.

If a user wants to connect to a wireless LAN access point then he initially transmits his wireless LAN name to the wireless LAN access point. This wireless LAN name comprises at most 32 characters and is identified in a wireless LAN selection menu of the mobile device, for example a smartphone, tablet computer, notebook or the like.

All available wireless LANs can be displayed to the user at any point in time without the installation of an additional program respectively of an additional application program such as an APP on the mobile device.

The wireless LAN name is further used for the purpose of identifying the field device and, on the other hand, the identification information, e.g. a 16 bit long identification information of the field device is also transmitted. For example the identification information is “GM100 Kamin1:WWS25TF23R1265TTF”.

By means of this information the user that wants to connect to the wireless LAN access point can obtain the required wireless LAN key.

For this purpose the user logs in to a web service known to him in the next step. If the authentication at the web service was successful, then the user arrives at the currently valid wireless LAN key of the field device by way of inputting the wireless LAN name. The web service is e.g. made available by the company SICK AG.

An important prerequisite furthermore consists therein that an identical algorithm for calculating an identical actual wireless LAN key has to respectively be present both at the field device and at the web service and/or respectively at the first module and the second module.

In a further development of the invention the wireless LAN access point transmits its wireless LAN name to the mobile device, wherein the wireless LAN name comprises identification information of the field device. For this purpose merely the wireless LAN name has to be transmitted which includes the identification information.

In a further development of the invention the identification information is applied at the field device and is input into the mobile device. For example, the identification information can directly be retrieved from the type plate of the field device. The identification information could also however be read off at a display of the field device.

In a further development of the invention the identification information is represented by a QR code at the field device, wherein the OR code is read by the mobile device.

By way of a QR code which is present in the vicinity of or directly at the field device an unambiguous identification can likewise take place. If the QR code is, for example, scanned, then the user is, for example, indicated the identification information respectively a code for the identification information which can be input at the web service. The OR code can also be present directly at the field device with a viewing contact to the field device. The QR code can, for example, be indicated at a display of a field device.

In a further development of the invention the mobile device transmits the identification information of the field device by way of a phone call, text messaging service/internet to the server having the web service.

If no internet connection is available to the user via which the web service can be accessed, then the wireless LAN key can also be queried with the aid of a code of the wireless LAN key also by way of a phone call.

If no internet connection is available to the user via which the web service can be reached, then the code present in the wireless LAN key can be sent by a text messaging service, e.g. by a text message (Short Message) to a known number. Subsequently the user obtains a response e.g. in turn again via a text messaging service, e.g. via a text message having the required wireless LAN key.

In a further development of the invention the field device is only connected to the mobile device via the wireless LAN access point. Thereby no further interfaces are required for the connection to the mobile device.

In a preferred embodiment of the invention the wireless LAN key is changed at least once a day. Thereby an access security is increased. Even if an unauthorized person came into possession of the wireless LAN key such an access would only be possible in a manner limited in time. The wireless LAN key also be changed in shorter periods of time, for example at least once an hour.

In a further development of the invention the wireless LAN name includes the serial number and/or the designation of the field device. Thereby only one wireless LAN name has to be transmitted, wherein the serial number and the designation of the field device are transmitted within the data format of the wireless LAN name.

In a preferred embodiment of the invention the wireless LAN name includes a resource identifier (URL, Uniform Resource Locator) via which access can directly be made to the web service. Thereby the connection to the web service can be directly produced on the basis of the wireless LAN name. In this respect the resource identifier is preinstalled with respect to the predefined desired web service, in particular of the manufacture of the field device.

In a further development of the invention the mobile device is logged in at the server having the web service by means of a user name and a password. Thereby a manipulation safety is enhanced, as a logging in at the web service can only take place with the knowledge of the access data, comprising a user name and a password.

In a further development, the mobile device transmits the identification information of the field device by means of a short message, in particular a text message, to the server having a web service; and/or the server transmits a wireless LAN key associated with the identification information by means of at least one short message, in particular a text message to the mobile device. Thereby a particularly simple standardized communication takes place between the mobile device and the web service that is also available on the simplest of mobile devices.

In a further development of the invention a software, in particular an application program for the mobile device, in particular a smartphone, is provided for carrying out the method.

By way of an application program respectively an APP an unambiguous identification can likewise take place. By way of selecting a network, the application program automatically connects to the web service and for a successful authentication at the web service automatically makes available the wireless LAN connection. Optionally a user name and a password are already stored in the application program.

The invention will be described in the following also with regard to further advantages and features with reference to the submitted drawing by means of embodiments. The FIGURE of the drawing shows in:

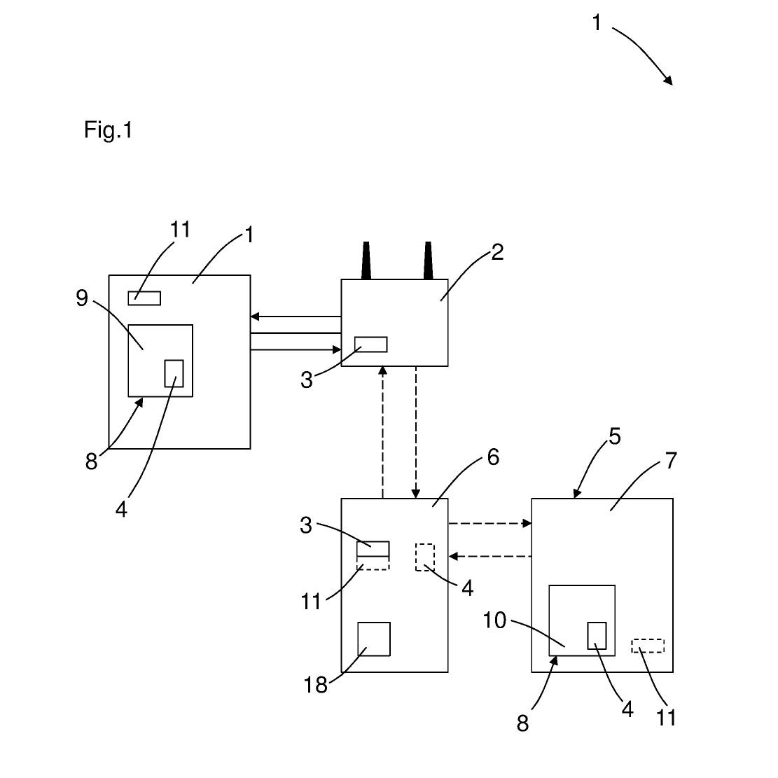

FIG. 1 an apparatus and a method for connecting a mobile device to a field device via a wireless LAN access point;

In the following FIGURE identical parts are referred to with identical reference numerals.

FIG. 1 shows a method respectively an apparatus for connecting a mobile device 6 to a field device 1 via a wireless LAN access point, wherein a server 5 having a web service 7 is provided, wherein the field device 1 has a first module 9 for generating a wireless LAN key 4, wherein the server 5 having a web service has a second module 10 for generating a wireless LAN key 4, wherein the first module 9 and the second module 10 are configured to respectively generate identical wireless LAN keys 4, wherein the field device 1 can be identified by the mobile device 6 by means of a piece of identification information 11, wherein the mobile device 6 is configured to transmit the identification information 11 of the field device 1 to the server 5 having the web service 7, wherein the server 5 having the web service 7 is configured to transmit the wireless LAN key 4 associated with the identification information 11 to the mobile device 6, wherein the mobile device 6 is wirelessly connected to the field device 1 via the wireless LAN access point 2 by means of the wireless LAN name 3 and the wireless LAN key 4.

Field devices 1 are, for example, field device of process automation, this means, for example transmitters, in particular O₂ transmitters, field devices for smoke gas investigation, such as e.g. particle measurement devices, laser scanners and the like.

When a user wants to connect to a wireless LAN access point 2 then the wireless LAN access point 2 initially transmits a wireless LAN name 3. This wireless LAN name 3 comprises at most 32 characters and is identified in a wireless LAN selection menu of the mobile device, for example a smartphone, a tablet computer, a notebook or the like.

All available wireless LANs can be indicated to the user at any point in time without the installation of an additional program respectively of an additional application program such as an APP at the mobile device 6.

The wireless LAN name 3 is, on the one hand, used for the purpose of identifying the field device 1 and, on the other hand, the identification information 11, e.g. a 16 bit long identification information 11 of the field device is also transmitted. For example the identification information is “GM100 Kamin1: WWS25TF23R1265TTF”.

With this information the user, who wants to connect the mobile device 6 to the wireless LAN access point 2, can obtain the required wireless LAN key 4.

For this purpose the user in the next step logs into a known web service 7. If the authentication at the web service 7 was successful, then the user arrives at the currently valid wireless LAN key 4 of the field device, through the input of the wireless LAN name 3. The web service 7 is e.g. made available by the company SICK AG.

An important prerequisite can furthermore consist therein that an identical algorithm for calculating an identical current wireless LAN key 4 must be present, respectively both at the field device and in the web service 7 and/or respectively in the first module 9 and the second module 10.

In accordance with FIG. 1 the wireless LAN access point 2 transmits its wireless LAN name 3 to the mobile device 6, wherein the wireless LAN name 3 has identification information 11 of the field device 1.

Optionally the identification information 11 is applied at the field device 1 and is input into the mobile device 6. For example, the identification information 11 can be retrieved directly from a type plate of the field device 1. The identification information 11 can also however be read at a display of the field device.

Furthermore, the identification 11 is optionally illustrated by a QR code at the field device 11, wherein the QR code is read by the mobile device 6.

If the OR code is, for example, scanned, then the user is, for example, indicated the identification information 11 respectively a code for the identification information 11 which can be input at the web service 7. The OR code can be present in viewing contact to the field device 1 also directly at the field device 1. The QR code can, for example, be indicated at a display of the field device 1.

In accordance with FIG. 1 the mobile device 6 transmits the identification information 11 of the field device 1 optionally by way of a telephone call/short messaging service or via the internet to the server 5 having the web server 7.

The field device 1 is optionally connected only via the wireless LAN access point 2 to the mobile device 6. The wireless LAN key 4 is, for example, changed at least once a day.

In accordance with FIG. 1 the wireless LAN name 3 includes a serial number and/or the designation of the field device 1. For example, the serial number and the designation of the field device 1 are transmitted within the data format of the wireless LAN name 3.

For example, the wireless LAN 3 includes a resource identifier via which one can directly access the web service 7. The resource identifier is in this connection, for example, preinstalled to the predefined desired web server 7.

For example, the mobile device 6 is logged in at the server 5 having the web service 7 by means of a user name and a password.

Optionally the mobile device 6 transmits the identification information 11 of the field device 1 by means of at least one short message, in particular a text message, to the server 5 having the web server 7; and/or the server 5 having the web service 7 transmits a wireless LAN key 4 associated with the identification information 11 by means of at least one short message, in particular a text message, to the mobile device 6.

In accordance with FIG. 1 software, in particular an application program 18 respectively an APP for a mobile device 6, in particular a smartphone, is provided for carrying out the method.

By way of an application program 18 respectively an APP an unambiguous identification can likewise take place. By way of selecting a network the application program 18 automatically connects to the web service 7 and on successful authentication of the web service 7 automatically makes available the wireless LAN connection. Optionally a user name and a password are already stored in the application program 18.

### LIST OF REFERENCE NUMERALS

1 field device

2 wireless LAN access point

3 wireless LAN name

4 wireless LAN key

5 server

6 mobile device

7 web service

8 module for generating the wireless LAN key

9 first module

10 second module

11 identification information

18 application program

1. A method of connecting a mobile device to a field device via a wireless LAN access point,
wherein a server having a web service is provided,
wherein the field device has a first module for generating a wireless LAN key,
wherein the server having the web service has a second module for generating a wireless LAN key,
wherein the first module and the second module respectively generate identical wireless LAN keys, the method comprising the steps of:
identifying the field device by the mobile device via at least one piece of identification information,
transmitting said identification information of the field device from the mobile device to the server having the web service,
transmitting the wireless LAN key associated with the identification information from the server having the web service to the mobile device, and
wirelessly connecting the mobile device to the field device via the wireless LAN access point by means of a wireless LAN name and the wireless LAN key.

2. The method in accordance with claim 1, further comprising the step of:
transmitting a wireless LAN name from the wireless LAN access point to the mobile device, wherein the wireless LAN name has said identification information of the field device.

3. The method in accordance with claim 1, wherein the identification information is attached at the field device and is input into the mobile device.

4. The method in accordance with claim 1, wherein the identification information is represented by a OR code at the field device, with the QR code being read by the mobile device.

5. The method in accordance with claim 1, further comprising the step of:
transmitting said identification information of the field device from the mobile device via a phone call, a text message service or via the internet to the server having the web service.

6. The method in accordance with claim 1, wherein the field device is only connected to the mobile device via the wireless LAN access point.

7. The method in accordance with claim 1, further comprising the step of:
changing the wireless LAN key at least once a day.

8. The method in accordance with claim 1, wherein the identification information includes the serial number and/or the designation of the field device.

9. The method in accordance with claim 1, wherein the wireless LAN name includes a resource identifier by means of which one can directly access the web service.

10. The method in accordance with claim 1, wherein the mobile device is logged in at the server having the web service by means of a user name and a password.

11. The method in accordance with claim 1, further comprising the step of:
transmitting said identification information of the field device from the mobile device by means of at least one of a short message and a text message to the server having the web service.

12. The method in accordance with claim 1, further comprising the step of:
transmitting a wireless LAN key associated with said identification information from the server having the web service by means of at least one short message and a text message to the mobile device.

13. Software for a mobile device for carrying out a method of connecting a mobile device to a field device via a wireless LAN access point,
wherein a server having a web service is provided,
wherein the field device has a first module for generating a wireless LAN key,
wherein the server having the web service has a second module for generating a wireless LAN key,
wherein the first module and the second module respectively generate identical wireless LAN keys, the method comprising the steps of:
identifying the field device by the mobile device via at least one piece of identification information,
transmitting said identification information of the field device from the mobile device to the server having the web service,
transmitting the wireless LAN key associated with the identification information from the server having the web service to the mobile device, and
wirelessly connecting the mobile device to the field device via the wireless LAN access point by means of a wireless LAN name and the wireless LAN key.

14. The software in accordance with claim 13, wherein it is an application program.

15. An apparatus for connecting a mobile device to a field device via a wireless LAN access point, wherein a server having a web service is provided,
wherein the field device has a first module for generating a wireless LAN key,
wherein the server having the web service has a second module for generating a wireless LAN key,
wherein the first module and the second module are configured to respectively generate identical wireless LAN keys,
wherein the field device can be identified via a piece of identification information by the mobile device,
wherein the mobile device is configured to transmit the identification information of the field device to the server having the web service,
wherein the server having the web service is configured to transmit the wireless LAN key associated with the identification information to the mobile device, and
wherein the mobile device is wirelessly connected to the field device via the wireless LAN access point by means of the wireless LAN name and the wireless LAN key.

16. The apparatus in accordance with claim 15, wherein the wireless LAN access point is configured to transmit a wireless LAN name to the mobile device, wherein the wireless LAN name has said identification information of the field device.

17. The apparatus in accordance with claim 15, wherein the wireless LAN name includes a resource identifier via which access to the web service can directly be made.

18. The apparatus in accordance with claim 15, wherein the mobile device is configured to transmit the identification information of the field device by means of at least one of a short message and a text message to the server having the web service.

19. The apparatus in accordance with claim 15, wherein the server having the web service is configured to transmit a wireless LAN key associated with the identification information by means of at least one of a short message and a text message to the mobile device.
